(19) United States
(12) Patent Application Publication
(10) Pub. No.: US 2024/0417246 A1
(43) Pub. Date: Dec. 19, 2024

(54) METHODS AND COMPOSITIONS FOR CONVERSION OF PLASTIC MATERIALS TO VALUE-ADDED PRODUCTS

(71) Applicant: West Virginia University Board of Governors on Behalf of West Virginia University, Morgantown, WV (US)

(72) Inventors: Yuxin WANG, Morgantown, WV (US); Jianli HU, Morgantown, WV (US)

(21) Appl. No.: 18/743,405

(22) Filed: Jun. 14, 2024

Related U.S. Application Data
(60) Provisional application No. 63/472,952, filed on Jun. 14, 2023.

(51) Int. Cl. C01B 3/02; B09B 3/70; B09B 101/75; C01B 32/15

(52) U.S. Cl. CPC C01B 3/02; B09B 3/70; C01B 32/15; B09B 2101/75; C01B 2203/0277; C01B 2203/0855; C01B 2203/1058; C01B 2203/1082; C01B 2203/1205; C01P 2002/01; C01P 2002/72; C01P 2002/88; C01P 2004/13; C01P 2004/64

(57) ABSTRACT

In one aspect, the disclosure relates to methods for converting a plastic, e.g., a waste plastic into value-added products, the method including the steps of (a) contacting the waste plastics with a catalyst to form a reaction mixture and (b) applying microwave irradiation to the reaction mixture, thereby forming the disclosed value-added products such as hydrogen and a carbon product, e.g., a carbon nanomaterial such as a carbon nanotube and/or a carbon nanofiber. A method for producing essentially Cox-free hydrogen gas is also disclosed.

### CROSS-REFERENCE TO RELATED APPLICATIONS

This application claims the benefit of U.S. Provisional Application No. 63/472,952, filed on Jun. 14, 2023, which is incorporated herein by reference in its entirety.

### BACKGROUND

In the last half-decade, 6 billion tons of waste plastic was generated. It is estimated that by 2025, 12 billion tons of plastic will be accumulated on the face of the planet [1]. Polyethylene contributes 36% of the total plastic market, making it the most utilized plastic [2]. According to current reports, a fraction of recyclable plastic (i.e., 15-18%) is recycled, and most of it ends up in landfills. Further, most single-use plastic (i.e., Low Density Polyethylene, LDPE; Polypropylene, PP; and Polystyrene, PS) is also ending up in landfills. Thus, plastic waste management needs urgent attention. Various recycling technologies were developed to address this problem; however, most face techno-economical limitations. Among plastic waste management methods, plastic recycling and incineration have a few limitations, i.e., greenhouse gas emission and water contamination. Plastic recycling facilities often struggle with separating and sorting different types of plastics. A single recycling facility can not recycle all plastics and/or prevent cross contaminations, and so cost-effectiveness becomes a considerable challenge. Alternatively, pyrolysis is a greener process capable of producing clean energy and value-added products from waste, e.g., waste plastic [3]. Further, pyrolysis can handle a mixture of different types of plastics, eliminating major limitations of recycling technologies [4].

Considering the exponential increase in demand for energy and environmental concerns, producing clean energy is a crucial area of research. Hydrogen is regarded as a potential energy carrier due to its applicability and versatility. Further, it has the highest calorific value with a non-polluting zero-carbon nature. COx-free hydrogen generation is one of the utmost essential research areas, as commercial hydrogen production methods are not entirely environmentally friendly [5]. Plastic waste could be considered an excellent feed for hydrogen production. Further, specific catalyst usage could convert its high carbon content into high-value carbon, e.g., carbon nanomaterials such as carbon nanotubes and carbon nanofibers.

Despite advances in plastic waste conversion research, there is still a scarcity of methods that offers high yields of value-added chemicals in a single step while using less energy and requiring less capital investment than currently available processes. Such methods would further reduce plastic landfill waste and strengthen energy security by providing a domestic source of Cox-free hydrogen and high-value carbon products such as carbon nanomaterials. These needs and other needs are met in whole or in part by the present disclosure.

### SUMMARY

In accordance with the purpose(s) of the present disclosure, as embodied and broadly described herein, the disclosure, in one aspect, relates to a method for converting a plastic, e.g., a waste plastic into value-added products, the method including the steps of (a) contacting the waste plastics with a catalyst to form a reaction mixture and (b) applying microwave irradiation to the reaction mixture. In another aspect, disclosed herein are value-added products including, but not limited to, hydrogen, and carbon nanoproducts.

Also disclosed are methods for converting a waste plastic to a value-added product, the method comprising: (a) providing waste plastic to a reactor; (b) contacting the waste plastic with a catalyst to form a reaction mixture; and (c) applying microwave radiation to the reaction mixture; thereby forming a value-added product; wherein the catalyst comprises, a solid acid catalyst, wherein the waste plastic comprises low-density polyethylene, high-density polyethylene, polypropylene, polystyrene, polyethylene terephthalate, polyurethane, clothing fibers, an epoxy plastic, or a combination thereof; and wherein the value-added product comprises a carbon nanofiber, a carbon nanotube, hydrogen, methane, or a combination thereof.

Also disclosed are compositions comprising at least one value-added product produced using a disclosed method.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a typical experimental configuration according to the present disclosure for converting plastic into value added products such as hydrogen and carbon nanotubes (CNT) and carbon nanofibers (CNF).

FIG. 2A is a pie graph which shows the results of an experiment according to the present disclosure wherein a plastic is converted to hydrogen gas, methane, and other materials using a 10% Fe/Al₂O₃ catalyst.

FIG. 2B is a pie graph which shows the results of an experiment according to the present disclosure wherein a plastic is converted to hydrogen gas, methane, and other materials using a 10% Ni/Al₂O₃ catalyst.

FIG. 2C is a pie graph which shows the results of an experiment according to the present disclosure wherein a plastic is converted to hydrogen gas, methane, and other materials using a 10% Co/Al₂O₃ catalyst.

FIG. 2D is a bar chart which shows the results of experiments according to the present disclosure wherein a plastic is converted to hydrogen gas, methane, and other materials using a 10% Fe/Al₂O₃ catalyst at different heating rates.

FIG. 3A shows three graphs of X-Ray Diffraction plots for spent, reduced, and calcined 10% Ni/Al₂O₃ according to the present disclosure.

FIG. 3B shows three graphs of X-Ray Diffraction plots for spent, reduced, and calcined 10% Fe/Al₂O₃ according to the present disclosure.

FIG. 3C shows three graphs of X-Ray Diffraction plots for spent, reduced, and calcined 10% Co/Al₂O₃ according to the present disclosure.

FIG. 4A shows a reduction curve of hydrogen uptake as a function of temperature during a temperature programmed reduction (TPR) process using 10% Ni/Al₂O₃ according to the present disclosure.

FIG. 4B shows a reduction curve of hydrogen uptake as a function of temperature during a temperature programmed reduction (TPR) process using 10% Fe/Al₂O₃ according to the present disclosure.

FIG. 4C shows a reduction curve of hydrogen uptake as a function of temperature during a temperature programmed reduction (TPR) process using 10% Co/Al₂O₃ according to the present disclosure.

FIG. 5A shows a thermographic analysis (TGA) graph of spent 10% Fe/Al₂O₃, spent 10% Ni/Al₂O₃, and spent 10% Co/Al₂O₃ in air.

FIG. 5B shows a differential scanning calorimetry (DSC) graph of spent 10% Fe/Al₂O₃, spent 10% Ni/Al₂O₃, and spent 10% Co/Al₂O₃ in air.

FIG. 6A, FIG. 6B, FIG. 6C, and FIG. 6D are high resolution transmission electron micrographs of carbon produced by the method of the present disclosure using a 10% Ni/Al₂O₃ catalyst.

FIG. 7A and FIG. 7B are high resolution transmission electron micrographs of carbon produced by the method of the present disclosure using a 10% Fe/Al₂O₃ catalyst.

FIG. 7C and FIG. 7D are high resolution transmission electron micrographs of carbon produced by the method of the present disclosure using a 10% Co/Al₂O₃ catalyst.

FIG. 8A shows a graph of a TGA analysis of the spent catalyst 10% Fe/Al₂O₃ in a nitrogen atmosphere. FIG. 8B shows a graph of a TGA analysis of the spent catalyst 10% Ni/Al₂O₃ in a nitrogen atmosphere. FIG. 8C shows a graph of a TGA analysis of the spent catalyst 10% Co/Al₂O₃ in a nitrogen atmosphere.

FIG. 9A and FIG. 9B are images of spent catalyst and carbon nanotubes and carbon nanofibers wherein the carbon nanotubes and carbon nanofibers are of lesser density than the spent catalyst.

FIG. 10A shows a graph of a TGA analysis of the spent 10% Fe/Al₂O₃ at 5° C./min in a nitrogen atmosphere. FIG. 10B shows a graph of a TGA analysis of the spent 10% Fe/Al₂O₃ at 10° C./min in a nitrogen atmosphere. FIG. 10C shows a graph of a TGA analysis of the spent 10% Fe/Al₂O₃ at 20° C./min in a nitrogen atmosphere. FIG. 10D shows a graph of a TGA analysis of the spent 10% Fe/Al₂O₃ at 40° C./min in a nitrogen atmosphere.

FIG. 11A and FIG. 11B show graphs of TGA analyses of plastic in a nitrogen and air atmospheres, respectively.

FIG. 12A, FIG. 12B, FIG. 12C, and FIG. 12D show graphs of TGA analyses of spent 10% Fe/Al₂O₃ at ramp rates of 5° C./min, 10° C./min, 20° C./min, and 40° C./min, respectively, in air.

FIG. 13A, FIG. 13B, and FIG. 13C show statistical distributions of carbon nanotubes according to outer diameter (in nm) for 10% Ni/Al₂O₃, 10% Ni/Al₂O₃ and 10% Ni/Al₂O₃, respectively.

FIG. 14 shows a product distribution of thermal decomposition of plastic films by 10% Fe/Al₂O₃ at 500° C. at a ramp rate of 20° C./min, produced by the method of the present disclosure.

FIG. 15A shows a graph of a TGA analysis a graph of a TGA analysis of the spent 10% Fe/Al₂O₃ of a non-microwave (MW) thermal plastic pyrolysis.

FIG. 15B is the graph of FIG. 15A with a heat flow air (Watts/gram) curve overlaid on the graph.

FIG. 16 is a thermal image of the catalyst bed using a FLIR thermal camera during the reaction according to the present disclosure.

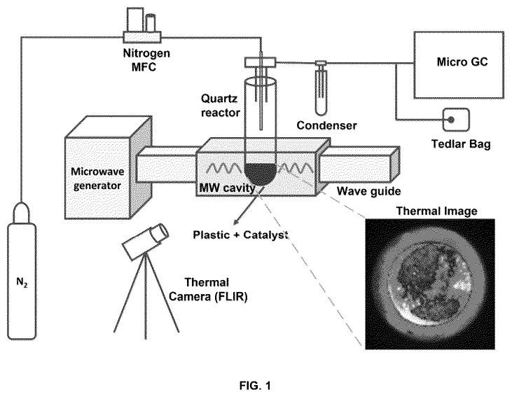

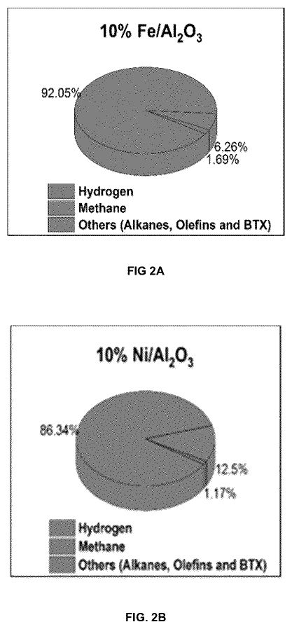

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “a metal oxide,” “an inert gas,” or “a catalyst,” includes, but is not limited to, two or more such substances.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are several values disclosed herein, and that each value is also herein disclosed as “about” that value in addition to the value itself. For example, if the value “10” is disclosed, then “about 10” is also disclosed. Ranges can be expressed herein as from “about” one value, and/or to “about” another value. Similarly, when values are expressed as approximations, by use of the antecedent “about,” it will be understood that the value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about “y”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a catalyst refers to an amount that is sufficient to achieve the desired improvement in the property modulated by the formulation component, e.g. achieving the desired level of waste plastic conversion and/or the desired product specificity. The specific level in terms of wt % in a composition required as an effective amount will depend upon a variety of factors including the amount and type of waste plastic, microwave power and resultant reaction temperature, particle size of both the catalyst and the waste plastic, and the desired product profile.

As used herein, the terms “optional” or “optionally” means that the subsequently described event or circumstance can or cannot occur, and that the description includes instances where said event or circumstance occurs and instances where it does not.

“Plastic” or “waste plastic” as used herein is any plastic material (e.g., low-density polyethylene, high-density polyethylene, polypropylene, polystyrene, polyethylene terephthalate, polyurethane, clothing fibers, epoxy plastics, and the like) that would otherwise be discarded. In some aspects, waste plastic is post-consumer waste (e.g., food containers, personal care product containers, and the like). In other aspects, waste plastic can be discarded after use in a healthcare or industrial setting, or can be a byproduct of an industrial process, or the like. Plastics may also include an acrylic, a polyamide, a polycarbonate, and/or a polyester.

“Value-added products” as used herein refers to decomposition products of waste plastic decomposition that have further industrial uses such as, for example, as fuels or fuel additives, solvents, or intermediates for synthesis of other products. Value-added products produced by the processes disclosed herein include, but are not limited to, hydrogen gas, methane gas, and/or carbon nanomaterials, e.g., carbon nanofibers and/or carbon nanotubes.

A “zeolite” as used herein refers to an aluminosilicate mineral with a microporous structure. Zeolites are, in one aspect, useful as catalysts for the processes disclosed herein. Zeolites can occur naturally or can be produced industrially.

A “solid acid” catalyst is an acidic catalyst that does not dissolve in the reaction medium. Solid acid catalysts can be Lewis acids, metal oxides, or the like, and, in one aspect, are useful as catalysts for the processes disclosed herein.

A “promoter” as used herein refers to a substance added to a catalyst to improve catalytic performance. In one aspect, a promoter can interact with a catalyst and alter its effect on the reaction in question, although promoters may not have catalytic effects on their own. In one aspect, promoters can be metal ions or atoms incorporated into metal oxides. Promoters useful herein include, but are not limited to Pt, Pd, Ru, Rh, Co, Mb, Ni, Fe, Mn, and combinations thereof.

“Microwave irradiation” refers to electromagnetic irradiation with a frequency of from about 0.3 to about 300 GHZ. In one aspect, in the method disclosed herein microwave irradiation can be applied to a mixture of a catalyst and waste plastic in order to convert the waste plastic into one or more value-added products.

Unless otherwise specified, temperatures referred to herein are based on atmospheric pressure (i.e. one atmosphere).

### B. Catalytic Conversion of Waste Plastics to Value-Added Products

In one aspect, the disclosure relates to a method for converting a waste plastic into one or more value-added product including, but not limited to, hydrogen, methane, or combinations thereof and/or carbon nanomaterials, e.g., carbon nanofibers and/or carbon nanotubes.

In one aspect, the plastic or waste plastic can be a polyolefin. In a further aspect, the polyolefin can be a low-density polyethylene (LDPE), high-density polyethylene (HDPE), polypropylene (PP), polystyrene (PS), polyethylene terephthalate (PET), polyurethanes (PU), clothing fibers, an epoxy plastic, another plastic, such as am acrylic, a polyamide, a polycarbonate, a polyester, or a combination thereof. In a further aspect, the waste plastic can be pelletized, chopped, cut, powdered, or otherwise reduced in size from bulk materials as presented in consumer and industrial plastic waste streams. In a yet further aspect, the waste plastic can be ground down to micron-sized particles prior to performing the method disclosed herein.

In one aspect, the catalyst may include an acidic support material, an in particular, an aluminum oxide. The aluminum oxide may be used in hydrate, polyhydrate, or anhydrous form. In an aspect, the acidic support material comprises a minimal amount of silicon dioxide, e.g., less than or equal to 20%, 15%, 10%, 5%, 4%, 3%, 2%, or 1% relative to the total weight of the acidic support material. In an aspect, the aluminum oxide is a γ-Al₂O₃.

In one aspect, the acidic support material may be an aluminum silicate, which may be amorphous or of a defined crystal structure. The aluminum silicate may be hydrated or anhydrous. In an aspect the aluminum silicate may be a naturally occurring crystal form. In an aspect, the aluminum silicate may be an andalusite, a kyanite, a sillimanite, a metakaolinite, a mullite, a kaolinite, e.g., a spinel, a metakaolin, and/or a platelet mullite.

In one aspect, the aluminum silicate may have a weight percent (wt %) of aluminum oxide (Al₂O₃) from about 1% to about 99%; or about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, or a range encompassing any of the foregoing values.

In one aspect, the acidic support material may be a zeolite. The zeolite generally has a Brønsted-acid site density of from about 50 μmol/g to about 1200 μmol/g of the zeolite wherein the Brønsted-acid site density as measured by a Brønsted-Acid Site Density Measurement Protocol. The Brønsted-Acid Site Density Measurement Protocol is found in the experimental protocols with the article: Kresnawahjuesa, O, “A Simple, Inexpensive, and Reliable Method for Measuring Brønsted-Acid Site Densities in Solid Acids”, Catalysis Letters, Volume 82, Issues 3-4, October 2002, pages 155-160.

In one aspect, the site density may be about 50, about 100, about 150, about 200, about 250, about 300, about 350, about 400, about 450, about 500, about 550, about 600, about 650, about 700, about 750, about 800, about 850, about 900, about 950, about 1000, about 1050, about 1100, about 1150, or about 1200 μmol/g, or a range encompassing any of the foregoing values.

In one aspect, the total pore volume of the acidic support material may be from about 0.1 cm³/g, about 0.15 cm³/g, about 0.2 cm³/g, about 0.25 cm³/g, about 0.30 cm³/g, about 0.35 cm³/g, about 0.40 cm³/g, about 0.45 cm³/g or about 0.50 cm³/g, or a range encompassing any of the foregoing values.

In another aspect, the acidic support material may have a surface area of from about 100 m²/g to about 450 m²/g, or of about 110, about 120, about 130, about 140, about 150, about 160, about 170, about 180, about 190, about 200, about 210, about 220, about 230, about 240, about 250, about 260, about 270, about 280, about 290, about 300, about 310, about 320, about 330, about 340, about 350, about 360, about 370, about 380, about 390, about 400, about 410, about 420, about 430, about 440, about 450, about 460, about 470, about 480, about 490, about 500 m²/g, or a range encompassing any of the foregoing values.

In another aspect, the acidic support material may have a mean pore diameter of about 1, about 2, about 3, about 4, about 5, about 6, about 7, about 8, about 9, about 10, about 11, about 12, about 13, about 14, about 15, about 16, about 17, about 18, about 19, or about 20 nm, or a range encompassing any of the foregoing values.

In one aspect, the amount of metal, e.g., Ni, Co, and/or Fe, in the catalyst composition may be from about 0.1, about 0.2, about 0.3, about 0.4, about 0.5, about 0.6, about 0.7, about 0.8, about 0.9, about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, or about 50 percent of the total weight of the metal and the acidic support material; the amount of the metal may fall within a range encompassing any of the foregoing values.

### Catalyst Promoters

In some aspects, the catalysts disclosed herein can be used in combination with metal promoters including, but not limited to, platinum, palladium, ruthenium, rhenium, cobalt, molybdenum, nickel, iron, manganese, another metal, or a combination thereof. In one aspect, PtNi/Al₂O₃ is a particularly effective catalyst.

### Reaction Process

### Sample Preparation and Reactor

In one aspect, the catalyst and plastic and/or waste plastic are ground up into small particles prior to performing the reactions disclosed herein. In a further aspect, the particles are approximately micron sized. In still another aspect, the catalyst: waste plastic mass ratio can be from about 20:1 to 1:20 or from about 10:1 to 1:10, or from about 1 to 5, or can be 0.1:20, 1:20, 1:15, 1:10, 1:9, 1:8, 1:7, 1:6, or about 1:5, or a combination of any of the foregoing values, or a range encompassing any of the foregoing values.

In another aspect, a mixed catalyst/plastic mass of about 0.5 g can be used in the reactions disclosed herein. In a further aspect, this mixture occupies a volume of about 0.6 cm³. However, in another aspect, the reaction can be scaled to another mass and volume to fit in a larger or differently-shaped reactor.

In one aspect, the reaction chamber can be a quartz tube. In another aspect, the reactor is a fixed-bed reactor. In a further aspect, the catalyst/plastic sample can be packed between two plugs of loose quartz wool.

In some aspects, the output gas composition can be measured by an inline gas chromatograph. In one aspect, a carrier gas can be used. In a further aspect, the carrier gas is an inert gas such as, for example, nitrogen. In still another aspect, the carrier gas can be introduced at room temperature and a flow rate of about 20 mL/min. Further in this aspect, the flow rate can be scaled depending on the size of the reactor. In another aspect, the carrier gas flow rate can be varied during the reaction.

### Reaction Temperatures

In one aspect, the reaction temperature as measured by IR thermography can be from about 180° C. to about 600° C., or from about 300 to about 500° C., or can be about 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, or about 600° C., or a combination of any of the foregoing values, or a range encompassing any of the foregoing values. In one aspect, the reaction temperature is about 300° C. In another aspect, the reaction temperature is about 400° C. In another aspect, the disclosed microwave-assisted reaction requires lower temperatures than traditional thermal heating but produces a greater yield of products.

Without wishing to be bound by theory, the catalyst particles absorb microwave radiation in the disclosed process and transfer heat to the waste plastic particles via conduction, as plastic waste typically has a low dielectric loss factor and cannot absorb microwave energy directly. Further in this aspect, both hot spots and cold spots exist within the reaction chamber. In one aspect, over the hot spots, plastic catalytically pyrolyzes to form H₂ and carbon nanomaterials.

### Reaction Times

In one aspect, the reaction can be carried out for any length of time required to obtain the desired product mixture. In a further aspect, the reaction can be carried out (i.e., microwave radiation can be applied) for from about 5 to about 30 minutes, or for about 5, 6, 7, 8, 9, 10, 11, 12, 13, 14, 15, 16, 17, 18, 19, 20, 21, 22, 23, 24, 25, 26, 27, 28, 29, or about 30 minutes, or a combination of any of the foregoing values, or a range encompassing any of the foregoing values.

### Reaction Pressure

In one aspect, the reaction can be carried out at a pressure of from about 1 to about 20 atm, or from about 1 to about 10 atm, or at about 1, 2, 3, 4, 5, 6, 7, 8, 9, 10, 11, 12, 13, 14, 15, 16, 17, 18, 19, or about 20 atm, or a combination of any of the foregoing values, or in a range encompassing any of the foregoing values.

### Reaction Products

The gaseous products of the reaction are generally hydrogen, methane and other gases, and substantially no COx products. In an aspect, the amount of hydrogen produced as a percentage of total gaseous product may be 80, 81, 82, 83, 84, 85, 86, 87, 88, 89, 90, 91, 92, 93, 94, 95, 96, 97, 98, 99% by volume at atmospheric pressure and ambient temperature. The amount of hydrogen produced may fall within a range encompassing any of the foregoing values.

In one aspect, the amount of a COx product, e.g., CO or CO₂ gas is less than 5%, or less than 4%, or less than 3% or less than 2%, or less than 1 percent of the total gaseous product by volume at atmospheric pressure and ambient temperature. In an aspect, the gaseous product is substantially free of COx, for example, less than 0.5%, or less than 0.4%, or less than 0.3%, or less than 0.2%, or less than 0.1% by volume at atmospheric pressure and ambient temperature.

In one aspect, the reaction may produce hydrogen gas in a yield of from 10 to 100 mmol/g plastic, or 10, 20, 30, 40, 50, 60, 70, 80, 90, or 100 mmol H₂/g plastic, or in a range encompassing any of the foregoing values.

In one aspect the percent carbon nanomaterial produced may be in a yield of about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, or about 95% of carbon based on the weight of carbon in the plastic and/or waste plastic.

### C. References

References are cited herein throughout using the format of reference number(s) enclosed by parentheses corresponding to one or more of the following numbered references. For example, citation of references numbers 1 and 2 immediately herein below would be indicated in the disclosure as [1] and [2].
[1] Ramzan F, Shoukat B, Naz M Y, Shukrullah S, Ahmad F, Naz I, et al. Single step microwaves assisted catalytic conversion of plastic waste into valuable fuel and carbon nanotubes. Thermochim Acta 2022; 715:179294. https://doi.org/10.1016/j.tca.2022.179294.
[2] Putra P H M, Rozali S, Patah M F A, Idris A. A review of microwave pyrolysis as a sustainable plastic waste management technique. J Environ Manage 2022; 303:114240. https://doi.org/10.1016/J.JENVMAN.2021.114240.
[3] Zhao X, Korey M, Li K, Copenhaver K, Tekinalp H, Celik S, et al. Plastic waste upcycling toward a circular economy. Chemical Engineering Journal 2022; 428:1-57. https://doi.org/10.1016/j.cej.2021.131928.
[4] Peng Y, Wang Y, Ke L, Dai L, Wu Q, Cobb K, et al. A review on catalytic pyrolysis of plastic wastes to high-value products. Energy Convers Manag 2022; 254:115243. https://doi.org/10.1016/J.ENCONMAN.2022.115243.
[5] Majumdar A, Deutch J M, Prasher R S, Griffin T P. A framework for a hydrogen economy. Joule 2021; 5:1905-8. https://doi.org/10.1016/j.joule.2021.07.007.
[6] Choo H, Jung Y, Jeong Y, Kim H C, Ku B-C. Fabrication and Applications of Carbon Nanotube Fibers. Carbon Letters 2012; 13:191-204. https://doi.org/10.5714/cl.2012.13.4.191.
[7] Martin A J, Mondelli C, Jaydev S D, Pérez-Ramirez J. Catalytic processing of plastic waste on the rise. Chem 2021; 7:1487-533. https://doi.org/10.1016/j.chempr.2020.12.006.
[8] Mishra R R, Sharma A K. Microwave-material interaction phenomena: Heating mechanisms, challenges and opportunities in material processing. Compos Part A Appl Sci Manuf 2016; 81:78-97. https://doi.org/10.1016/j.compositesa.2015.10.035.
[9] Yao D, Zhang Y, Williams P T, Yang H, Chen H. Co-production of hydrogen and carbon nanotubes from real-world waste plastics: Influence of catalyst composition and operational parameters. Appl Catal B 2018; 221:584-97. https://doi.org/10.1016/j.apcatb.2017.09.035.
[10] Liu X, Zhang Y, Nahil M A, Williams P T, Wu C. Development of Ni- and Fe-based catalysts with different metal particle sizes for the production of carbon nanotubes and hydrogen from thermo-chemical conversion of waste plastics. J Anal Appl Pyrolysis 2017; 125:32-9. https://doi.org/10.1016/j.jaap.2017.05.001.
[11] Zhang Y S, Zhu H L, Yao D, Williams P T, Wu C, Xu D, et al. Thermo-chemical conversion of carbonaceous wastes for CNT and hydrogen production: A review. Sustain Energy Fuels 2021; 5:4173-208. https://doi.org/10.1039/d1se00619c.
[12] Jie X, Li W, Slocombe D, Gao Y, Banerjee I, Gonzalez-Cortes S, et al. Microwave-initiated catalytic deconstruction of plastic waste into hydrogen and high-value carbons. Nat Catal 2020; 3:902-12. https://doi.org/10.1038/s41929-020-00518-5.
[13] Wang J, Pan Y, Song J, Huang Q. A high-quality hydrogen production strategy from waste plastics through microwave-assisted reactions with heterogeneous bimetallic iron/nickel/cerium catalysts. J Anal Appl Pyrolysis 2022; 166:105612. https://doi.org/10.1016/j.jaap.2022.105612.
[14] Yao L, Yi B, Zhao X, Wang W, Mao Y, Sun J, et al. Microwave-assisted decomposition of waste plastic over Fe/FeAl2O4 to produce hydrogen and carbon nanotubes. J Anal Appl Pyrolysis 2022; 165:105577. https://doi.org/10.1016/j.jaap.2022.105577.
[15] Shen X, Zhao Z, Li H, Gao X, Fan X. Microwave-assisted pyrolysis of plastics with iron-based catalysts for hydrogen and carbon nanotubes production. Mater Today Chem 2022; 26. https://doi.org/10.1016/j.mtchem.2022.101166.
[16] Wang H, Zhang B, Luo P, Huang K, Zhou Y. Simultaneous Achievement of High-Yield Hydrogen and High-Performance Microwave Absorption Materials from Microwave Catalytic Deconstruction of Plastic Waste. Processes 2022; 10. https://doi.org/10.3390/pr10040782.
[17] Gholizadeh F, Izadbakhsh A, Huang J, Zi-Feng Y. Catalytic performance of cubic ordered mesoporous alumina supported nickel catalysts in dry reforming of methane. Microporous and Mesoporous Materials 2021; 310:110616. https://doi.org/10.1016/j.micromeso.2020.110616.
[18] Lee J Y, Jun K W, Kang S C, Zhang C, Kwak G, Park J M, et al. Fe—Co/alumina catalysts for production of high calorific synthetic natural gas: Effect of Fe/Co ratio. Journal of Industrial and Engineering Chemistry 2018; 66:396-403. https://doi.org/10.1016/j.jiec.2018.06.006.
[19] Parmar K R, Pant K K, Roy S. Blue hydrogen and carbon nanotube production via direct catalytic decomposition of methane in fluidized bed reactor: Capture and extraction of carbon in the form of CNTs. Energy Convers Manag 2021; 232:113893. https://doi.org/10.1016/j.enconman.2021.113893.
[20] Monthioux M, Noe L, Dussault L, Dupin J C, Latorre N, Ubieto T, et al. Texturising and structurising mechanisms of carbon nanofilaments during growth. J Mater Chem 2007; 17:4611-8. https://doi.org/10.1039/b707742d.
[21] Ermakova M A, Ermakov D Y, Chuvilin A L, Kuvshinov G G. Decomposition of Methane over Iron Catalysts at the Range of Moderate Temperatures: The Influence of Structure of the Catalytic Systems and the Reaction Conditions on the Yield of Carbon and Morphology of Carbon Filaments. J Catal 2001; 201:183-97. https://doi.org/10.1006/JCAT.2001.3243.
[22] Zhao Z, Shen X, Li H, Liu K, Wu H, Li X, et al. Watching Microwave-Induced Microscopic Hot Spots via the Thermosensitive Fluorescence of Europium/Terbium Mixed-Metal Organic Complexes. Angewandte Chemie-International Edition 2022; 61. https://doi.org/10.1002/anie.202114340.
[23] Fan L, Zhang Y, Liu S, Zhou N, Chen P, Liu Y, et al. Ex-situ catalytic upgrading of vapors from microwave-assisted pyrolysis of low-density polyethylene with MgO. Energy Convers Manag 2017; 149:432-41. https://doi.org/10.1016/j.enconman.2017.07.039.
[24] Jourdain V, Bichara C. Current understanding of the growth of carbon nanotubes in catalytic chemical vapour deposition. Carbon N Y 2013; 58:2-39. https://doi.org/10.1016/j.carbon.2013.02.046.
[25] Yao D, Wang C H. Pyrolysis and in-line catalytic decomposition of polypropylene to carbon nanomaterials and hydrogen over Fe- and Ni-based catalysts. Appl Energy 2020; 265: 114819. https://doi.org/10.1016/j.apenergy.2020.114819.

### D. Aspects

The following listing of exemplary aspects supports and is supported by the disclosure provided herein.

Aspect 1. A method for converting a plastic composition to value-added products, the method comprising: providing a plastic composition to a reactor; (a) contacting the plastic composition with a catalyst to form a reaction mixture; and (b) applying microwave radiation to the reaction mixture to heat the reaction mixture to a reaction temperature; thereby forming the value-added products; wherein the value-added products comprise a gaseous product and a solid product; wherein the gaseous product comprises hydrogen; and wherein the solid product comprises a carbon nanomaterial; wherein the catalyst comprises a catalyst support and a catalyst metal; wherein the catalyst support comprises an acidic support material; and wherein the catalyst metal is selected from Fe, Co, Ni, and combinations thereof; and wherein the reaction temperature is from about 180° C. to about 600° C.

Aspect 2. The method of Aspect 1, wherein the plastic composition is a waste plastic composition.

Aspect 3. The method of Aspect 1 or Aspect 2, wherein the plastic composition is selected from the group consisting of an acrylic, polyamide, a polycarbonate, a polyester, a polyolefin, a polystyrene, and combinations thereof.

Aspect 4. The method of any one of Aspect 1-Aspect 3 wherein the acrylic is selected from the group consisting of an acrylate polymer, an acrylic resin, an acrylic fiber, and acrylic paint, a methacrylate polymer, a methacrylate resin, an alkyl methacrylate polymer, and an alkyl methacrylate resin.

Aspect 5. The method of any one of Aspect 1-Aspect 4 wherein the polyamide is selected from the group consisting of an aliphatic polyamide, a polyphthalamide, and an aromatic polyamide.

Aspect 6. The method of any one of Aspect 1-Aspect 5 wherein the polyester is selected from the group consisting of a linear aliphatic polyester wherein an Mn is an integer from 104 to 106, a linear aliphatic polyester wherein an Mn is an integer from 102 to 104, a hyperbranched polyester; an aliphatic-aromatic polyester, an aromatic polyester; and an aromatic polyester.

Aspect 7. The method of any one of Aspect 1-Aspect 6, wherein the polyolefin is selected from the group consisting of a polyurethane, a polyethylene, a polypropylene, a polybutylene, and combinations thereof.

Aspect 8. The method of any one of Aspect 1-Aspect 7, wherein the polyolefin is selected from the group consisting of a low-density polyethylene, a high-density polyethylene, a polypropylene, a polystyrene, a polyethylene terephthalate, a polyurethane, an epoxy plastic, and combinations thereof.

Aspect 9. The method of any one of Aspect 1-Aspect 8, wherein the acidic support material comprises aluminum oxide.

Aspect 10. The method of any one of Aspect 1-Aspect 9, wherein the aluminum oxide has a silica content in SiO2 equivalent less than or equal to about 10 wt % relative to the total weight of the acidic support material.

Aspect 11. The method of any one of Aspect 1-Aspect 10, wherein the aluminum oxide has a silica content in SiO2 equivalent less than or equal to about 5 wt % relative to the total weight of the acidic support material.

Aspect 12. The method of any one of Aspect 1-Aspect 11, wherein the aluminum oxide has a silica content in SiO2 equivalent less than or equal to about 2 wt % relative to the total weight of the acidic support material.

Aspect 13. The method of any one of Aspect 1-Aspect 12, wherein the aluminum oxide is γ-Al2O3.

Aspect 14. The method of any one of Aspect 1-Aspect 13, wherein the acidic support material comprises an aluminum silicate.

Aspect 15. The method of Aspect 14, wherein the aluminum silicate is amorphous.

Aspect 16. The method of Aspect 14 or Aspect 15, wherein the aluminum silicate comprises Si—O—Al bonds.

Aspect 17. The method of any one of Aspect 14-Aspect 16 wherein the aluminum silicate is hydrated.

Aspect 18. The method of any one of Aspect 14-17 wherein the aluminum silicate is selected from the group consisting of an andalusite, a kyanite, a sillimanite, a metakaolinite, a mullite and a kaolinite.

Aspect 19. The method of Aspect 18 wherein the kaolinite is selected from the group consisting of a spinel, a metakaolin, and a platelet mullite.

Aspect 20. The method of any one of Aspect 14-Aspect 19 wherein the aluminum silicate is anhydrous.

Aspect 21. The method of any one of Aspect 14-Aspect 16, wherein the aluminum silicate has a formula xAl₂O₃·ySiO₂; wherein x is an integer from 1 to 10; and wherein y is an integer from 1 to 10.

Aspect 22. The method of any one of Aspect 14-Aspect 21, wherein the aluminum silicate has a wt % of Al₂O₃ from about 5 wt % to about 99 wt %.

Aspect 23. The method of Aspect 22, wherein the aluminum silicate has a wt % of Al₂O₃ from about 10 wt % to about 99 wt %.

Aspect 24. The method of Aspect 22, wherein the aluminum silicate has a wt % of Al₂O₃ from about 20 wt % to about 99 wt %.

Aspect 25. The method of Aspect 22, wherein the aluminum silicate has a wt % of Al₂O₃ from about 30 wt % to about 99 wt %.

Aspect 26. The method of Aspect 22, wherein the aluminum silicate has a wt % of Al₂O₃ from about 40 wt % to about 99 wt %.

Aspect 27. The method of Aspect 22, wherein the aluminum silicate has a wt % of Al₂O₃ from about 50 wt % to about 99 wt %.

Aspect 28. The method of Aspect 22, wherein the aluminum silicate has a wt % of Al₂O₃ from about 60 wt % to about 99 wt %.

Aspect 29. The method of Aspect 22, wherein the aluminum silicate has a wt % of Al₂O₃ from about 70 wt % to about 99 wt %.

Aspect 30. The method of Aspect 22, wherein the aluminum silicate has a wt % of Al₂O₃ from about 80 wt % to about 99 wt %.

Aspect 31. The method of Aspect 22, wherein the aluminum silicate has a wt % of Al₂O₃ from about 90 wt % to about 99 wt %.

Aspect 32. The method of Aspect 22, wherein the aluminum silicate has a wt % of Al₂O₃ from about 5 wt % to about 90 wt %.

Aspect 33. The method of Aspect 22, wherein the aluminum silicate has a wt % of Al₂O₃ from about 10 wt % to about 90 wt %.

Aspect 34. The method of Aspect 22, wherein the aluminum silicate has a wt % of Al₂O₃ from about 20 wt % to about 90 wt %.

Aspect 35. The method of Aspect 22, wherein the aluminum silicate has a wt % of Al₂O₃ from about 30 wt % to about 90 wt %.

Aspect 36. The method of Aspect 22, wherein the aluminum silicate has a wt % of Al₂O₃ from about 40 wt % to about 90 wt %.

Aspect 37. The method of Aspect 22, wherein the aluminum silicate has a wt % of Al₂O₃ from about 50 wt % to about 90 wt %.

Aspect 38. The method of Aspect 22, wherein the aluminum silicate has a wt % of Al₂O₃ from about 60 wt % to about 90 wt %.

Aspect 39. The method of Aspect 22, wherein the aluminum silicate has a wt % of Al₂O₃ from about 70 wt % to about 90 wt %.

Aspect 40. The method of Aspect 22, wherein the aluminum silicate has a wt % of Al₂O₃ from about 80 wt % to about 90 wt %.

Aspect 41. The method of any one of Aspect 14-Aspect 40, wherein the aluminum silicate is 3Al₂O₃·2SiO2.

Aspect 42. The method of any one of Aspect 1 to Aspect 41 wherein the acidic support material comprises a zeolite.

Aspect 43. The method of Aspect 42, wherein the acidic support material comprises a protonated zeolite.

Aspect 44. The method of Aspect 41 or Aspect 42, wherein the acidic support material comprises Y zeolite.

Aspect 45. The method of any one of Aspect 42-Aspect 44, wherein the zeolite has a Brønsted-acid site density of from about 50 μmol/g to about 1200 μmol/g of the zeolite wherein the Brønsted-acid site density as measured by the Brønsted-Acid Site Density Measurement Protocol.

Aspect 46. The method of Aspect 45 wherein the Brønsted-acid site density is from about 100 μmol/g to about 1000 μmol/g.

Aspect 47. The method of 44 wherein the Brønsted-acid site density is from about 200 μmol/g to about 1000 μmol/g.

Aspect 48. The method of 44 wherein the Brønsted-acid site density is from about 300 μmol/g to about 900 μmol/g.

Aspect 49. The method of 44 wherein the Brønsted-acid site density is from about 300 μmol/g to about 800 μmol/g.

Aspect 50. The method of 44 wherein the Brønsted-acid site density is from about 300 μmol/g to about 700 μmol/g.

Aspect 51. The method of any one of Aspect 1-Aspect 45, wherein the acidic support material has a total pore volume from about 0.1 cm³/g to about 0.5 cm³/g.

Aspect 52. The method of Aspect 51, wherein the acidic support material has a total pore volume from about 0.2 cm³/g to about 0.4 cm³/g.

Aspect 53. The method of Aspect 51, wherein the acidic support material has a total pore volume from about 0.25 cm³/g to about 0.35 cm³/g.

Aspect 54. The method of any one of Aspect 1-Aspect 53, wherein the acidic support material has a specific surface area from about 100 m²/g to about 300 m²/g.

Aspect 55. The method of Aspect 54, wherein the acidic support material has a specific surface area from about 100 m²/g to about 200 m²/g.

Aspect 56. The method of Aspect 54, wherein the acidic support material has a specific surface area from about 125 m²/g to about 150 m²/g.

Aspect 57. The method of any one of Aspect 1-Aspect 56, wherein the acidic support material comprises pores with a mean pore diameter from about 2 nm to about 20 nm.

Aspect 58. The method of Aspect 57, wherein the acidic support material comprises pores with a mean pore diameter from about 3 nm to about 15 nm.

Aspect 59. The method of Aspect 57, wherein the acidic support material comprises pores with a mean pore diameter from about 5 nm to about 10 nm.

Aspect 60. The method of any one of Aspect 1-Aspect 59, wherein the gaseous product comprises from about 85% to 100% hydrogen gas by volume at atmospheric pressure and ambient temperature.

Aspect 61. The method of Aspect 60, wherein the gaseous product comprises from about 85% to 99% hydrogen gas by volume at atmospheric pressure and ambient temperature.

Aspect 62. The method of Aspect 60, wherein the gaseous product comprises from about 90% to 99% hydrogen gas by volume at atmospheric pressure and ambient temperature.

Aspect 63. The method of Aspect 60, wherein the gaseous product comprises from about 92% to 99% hydrogen gas by volume at atmospheric pressure and ambient temperature.

Aspect 64. The method of Aspect 60, wherein the gaseous product comprises from about 94% to 99% hydrogen gas by volume at atmospheric pressure and ambient temperature.

Aspect 65. The method of any one of Aspect 1-Aspect 64, wherein the gaseous product contains less than 1% of a COx gas by volume at atmospheric pressure and ambient temperature.

Aspect 66. The method of any one of Aspect 1-Aspect 65, wherein the gaseous product is substantially free of a COx gas.

Aspect 67. The method of any one of Aspect 1-Aspect 66, wherein the catalyst and plastic composition are present in a w/w ratio from about 20:1 to about 1:20.

Aspect 68. The method of Aspect 67, wherein the catalyst and plastic composition are present in a w/w ratio from about 10:1 to about 1:1.

Aspect 69. The method of any one of Aspect 1-Aspect 68, wherein microwave irradiation is applied to the reaction mixture for from about 5 minutes to about 30 minutes.

Aspect 70. The method of any one of Aspect 1-Aspect 69, wherein the microwave irradiation has a frequency of from about 915 MHz to about 20 GHz.

Aspect 71. The method of Aspect 70, wherein the microwave irradiation has a frequency of from about 915 MHz to about 10 GHz.

Aspect 72. The method of Aspect 70, wherein the microwave irradiation has a frequency of from about 915 MHz to about 5 GHz.

Aspect 73. The method of any one of Aspect 1-Aspect 72, wherein the microwave irradiation heats the reaction mixture to a bulk temperature from about 200° C. to about 600° C.

Aspect 74. The method of Aspect 72, wherein the microwave irradiation heats the reaction mixture to a bulk temperature from about 250° C. to 600° C.

Aspect 75. The method of Aspect 72, wherein the microwave irradiation heats the reaction mixture to a bulk temperature from about 200° C. to 500° C.

Aspect 76. The method of Aspect 72, wherein the microwave irradiation heats the reaction mixture to a bulk temperature from about 250° C. to 500° C.

Aspect 77. The method of Aspect 72, wherein the microwave irradiation heats the reaction mixture to a bulk temperature from about 200° C. to 400° C.

Aspect 78. The method of Aspect 72, wherein the microwave irradiation heats the reaction mixture to a bulk temperature from about 250° C. to 400° C.

Aspect 79. The method of Aspect 72, wherein the microwave irradiation heats the reaction mixture to a bulk temperature from about 200° C. to 300° C.

Aspect 80. The method of Aspect 72, wherein the microwave irradiation heats the reaction mixture to a bulk temperature from about 250° C. to 300° C.

Aspect 81. The method of Aspect 72, wherein the microwave irradiation heats the reaction mixture to a bulk temperature from about 270° C. to 300° C.

Aspect 82. The method of any one of Aspect 1-Aspect 81, wherein the hydrogen is produced in a yield of from 20 to 60 mmol H₂ per gram of plastic composition.

Aspect 83. The method of Aspect 82, wherein the hydrogen is produced in a yield of from 30 to 50 mmol H₂ per gram of plastic composition.

Aspect 84. The method of Aspect 82, wherein the hydrogen is produced in a yield of from 30 to 45 mmol H₂ per gram of plastic composition.

Aspect 85. The method of any one of Aspect 1-Aspect 84, wherein the carbon nanomaterial in a yield from about 80% to about 99% carbon based on the weight of carbon in the plastic composition.

Aspect 86. The method of Aspect 85, wherein the carbon nanomaterial in a yield from about 85% to 99% carbon based on the weight of carbon in the plastic composition.

Aspect 87. The method of Aspect 85, wherein the carbon nanomaterial in a yield from about 90% to 99% carbon based on the weight of carbon in the plastic composition.

Aspect 88. The method of Aspect 85, wherein the carbon nanomaterial in a yield from about 95% to 99% carbon based on the weight of carbon in the plastic composition.

Aspect 89. The method of any one of Aspect 1-Aspect 88, wherein the carbon nanomaterial is selected from a carbon nanofiber, a carbon nanotube, and combinations thereof.

Aspect 90. The method of any one of Aspect 1-Aspect 89, wherein the catalyst metal is present in an amount from about 0.1 wt % to about 40 wt % metal based on the total weight of the support and the metal.

Aspect 91. The method of Aspect 90, wherein the catalyst metal is present in an amount from about 0.3 wt % to about 40 wt % metal based on the total weight of the support and the metal.

Aspect 92. The method of Aspect 90, wherein the catalyst metal is present in an amount from about 0.3 wt % to about 30 wt % metal based on the total weight of the support and the metal.

Aspect 93. The method of Aspect 90, wherein the catalyst metal is present in an amount from about 0.3 wt % to about 20 wt % metal based on the total weight of the support and the metal.

Aspect 94. The method of Aspect 90, wherein the catalyst metal is present in an amount from about 0.3 wt % to about 15 wt % metal based on the total weight of the support and the metal.

Aspect 95. The method of Aspect 90, wherein the catalyst metal is present in an amount from about 0.3 wt % to about 10 wt % metal based on the total weight of the support and the metal.

Aspect 96. The method of Aspect 90, wherein the catalyst metal is present in an amount from about 0.5 wt % to about 40 wt % metal based on the total weight of the support and the metal.

Aspect 97. The method of Aspect 90, wherein the catalyst metal is present in an amount from about 0.5 wt % to about 30 wt % metal based on the total weight of the support and the metal.

Aspect 98. The method of Aspect 90, wherein the catalyst metal is present in an amount from about 0.5 wt % to about 20 wt % metal based on the total weight of the support and the metal.

Aspect 99. The method of Aspect 90, wherein the catalyst metal is present in an amount from about 0.5 wt % to about 15 wt % metal based on the total weight of the support and the metal.

Aspect 100. The method of Aspect 90, wherein the catalyst metal is present in an amount from about 0.5 wt % to about 10 wt % metal based on the total weight of the support and the metal.

Aspect 101. The method of any one of Aspect 1-Aspect 100, wherein the catalyst metal is selected from Ni, Co, and Fe.

Aspect 102. The method of Aspect 101, wherein the catalyst metal is Ni.

Aspect 103. The method of Aspect 101, wherein the catalyst metal is Co.

Aspect 104. The method of Aspect 101, wherein the catalyst metal is Fe.

Aspect 105. The method of Aspect 101, wherein the catalyst metal comprises Ni and Co.

Aspect 106. The method of Aspect 105, wherein the catalyst metal comprises Ni and Fe.

Aspect 107. The method of any one of Aspect 1-Aspect 106 wherein the catalyst further comprises a catalyst promoter metal.

Aspect 108. The method of Aspect 107, wherein the catalyst promoter metal is selected from Pt, Pd, and a combination thereof.

Aspect 109. The method of any one of Aspect 1-Aspect 108, wherein the catalyst metal is produced by hydrogenation of a catalyst oxide selected from the group consisting of a nickel oxide, an iron oxide, and a cobalt oxide.

Aspect 110. A carbon nanomaterial made using the method of any one of Aspect 1-Aspect 109.

Aspect 111. The carbon nanomaterial of Aspect 110 wherein the carbon nanomaterial is selected from the group consisting of a carbon nanofiber, a carbon nanotube, and combinations thereof.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### E. Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Materials

Polypropylene (real-world plastic film) was purchased from a local market. The plastic film was cut into small pieces and then heated in an oven at 150° C. for two hours. Using a blender, the heated films were ground to a fine powder and sieved to obtain <150-micron particles. Aluminum oxide (gamma phase) nanopowder was purchased from Alfa Aesar. Nickel (II) nitrate hexahydrate, Ferric nitrate nonahydrate, and Cobalt (II) nitrate hexahydrate were purchased from Acros Organics, Fisher Chemicals, and Sigma-Aldrich, respectively.

### 2. Catalyst Preparation:

Catalysts were prepared by a wet impregnation method. Measured amounts of metal salts (Nickel, Iron, Cobalt) were dissolved in distilled water to make a solution. A calculated quantity of aluminum oxide was added to the solution to form a slurry. After stirring for two hours, the water was evaporated from the slurry. The resulting cake was air-dried in the oven (120° C., 12 h) and calcinated at 550° C. in the muffle furnace (3° C. min⁻¹, 5 h).

### 3. Catalyst Characterization

Different analytical tools were used to characterize the calcined catalysts, spent catalysts, and carbon nanotubes (CNTs). The redox behavior of the calcined catalysts was analyzed by hydrogen temperature-programmed reduction (TPR). In a typical procedure, 10 vol. % H₂/Ar (50 mL/min) mixture was passed over the catalyst from room temperature to 900° C. with a 10° C./min ramp rate, and hydrogen consumption was measured simultaneously (Micromeritics Autochem HP2950). Prior to the TPR analysis, the sample was degassed at 150° C. for one hour under helium flow (30 mL/min). CO chemisorption was utilized to estimate the dispersion (%), active metal surface area (m²/g), and metal crystallite size. X-ray diffraction (XRD) method was employed to determine d-spacing and crystal phases of the calcined and spent catalysts. XRD spectra were collected by PANanalytical X′pert pro-X-ray diffractometer (PW3040). It was operated at 40 kV, 20 mA to obtain a scan range of 10 to 110° with 0.0167 deg/step and 5°/min scan rate. The internal morphologies of the prepared samples were collected by a high-resolution electron microscope (JEOL JEM-2100) operated at 200 kV. For creating the outside diameter (OD) size distribution data of CNTs, ImageJ software was utilized. The thermal stability of the samples was checked by Thermo-gravimetric analysis (TGA) (TA instruments, SDT Q650). In a typical procedure, the spent catalyst was heated in the presence of nitrogen to evaluate the residue plastic content. Then the same spent catalyst was again heated in the presence of air to determine the carbon content and stability.

### 4. Experimental Setup

Plastic pyrolysis was conducted in a quartz tube reactor placed inside a Sairem microwave system. All reactions were carried out at 2.45 GHZ, and the maximum power was 900 W. An infrared pyrometer was used for the temperature measurement, and forward power was controlled using a PID controller. A Eurotherm controller was used to regulate the microwave power and tuning. A thermal camera (Model A6261) was also used to capture real-time thermal videos/images during the reaction. For plastic pyrolysis, the catalyst and polymer were mixed in the quartz tube according to a predefined ratio. The whole reaction assembly, including the quartz tube, was purged with inert gas (i.e., nitrogen) for 30 min at 100 mL/min flow to ensure an oxygen-free atmosphere. The nitrogen gas (5 mL/min) was used as a carrier gas, and the entire assembly was leak-tested. After starting the microwave generator, the temperature was increased to 300° C. at predefined ramp rates. All the reactions were performed for 30 mins and at atmospheric pressure. All the reaction conditions are disclosed in Table 1. Product gas was collected in a Tedlar bag and was analyzed by a four-channel micro gas chromatograph (Inficon 3000). For a comparison, some reactions were performed by using conventional/electrical heating. The plastic-catalyst sample was heated to 300 and 500° C. at the required ramp rate using an electric furnace. All other steps were the same as in the microwave procedure.

TABLE 1

| | | | | Reaction | |
|---|---|---|---|---|---|
| Sr | | Catalyst | Plastic | temperature | Ramp rate |
| No | Catalyst | wt. (g) | wt. (g) | (° C.) | (° C./min) |
| 1 | 10% Ni/Al₂O₃ | 1.5 | 0.5 | 300 | 20 |
| 2 | 10% Fe/Al₂O₃ | 1.5 | 0.5 | 300 | 20 |
| 3 | 10% Co/Al₂O₃ | 1.5 | 0.5 | 300 | 20 |
| 4 | 10% Fe/Al₂O₃ | 1.5 | 0.5 | 300 | 5 |
| 5 | 10% Fe/Al₂O₃ | 1.5 | 0.5 | 300 | 10 |
| 6 | 10% Fe/Al₂O₃ | 1.5 | 0.5 | 300 | 20 |
| 7 | 10% Fe/Al₂O₃ | 1.5 | 0.5 | 300 | 40 |
| 8 | 10% Fe/Al₂O₃ | 1.5 | 0.5 | 300 (non-MW) | 20 |
| 9 | 10% Fe/Al₂O₃ | 1.5 | 0.5 | 500 (non-MW) | 20 |

### 5. Catalyst Performance

The yield of hydrogen was utilized as a measurement of catalyst performance. The hydrogen yield is defined as mmol of H₂ produced/g of plastic.

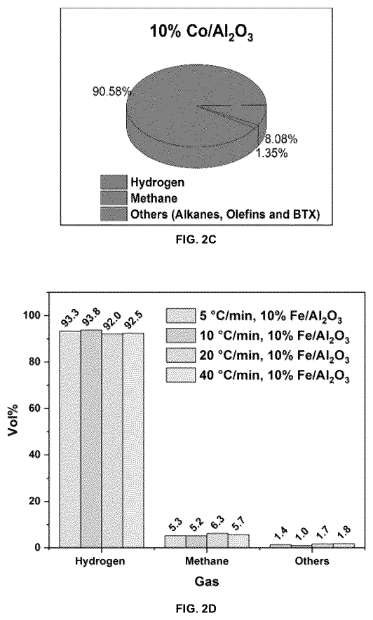

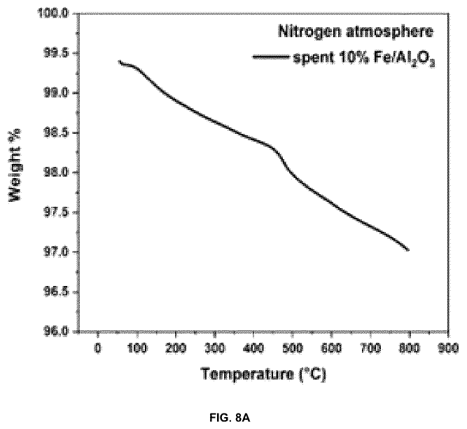

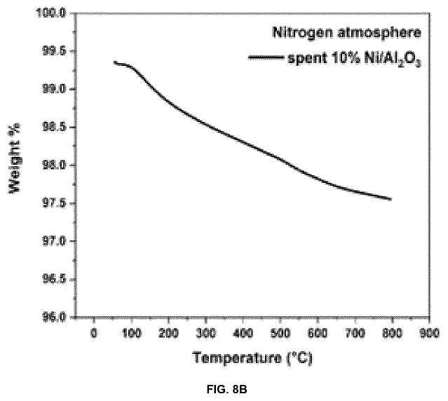

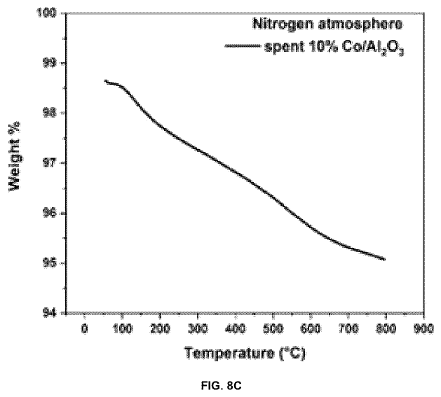

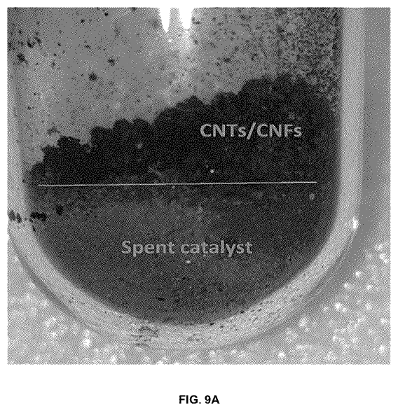

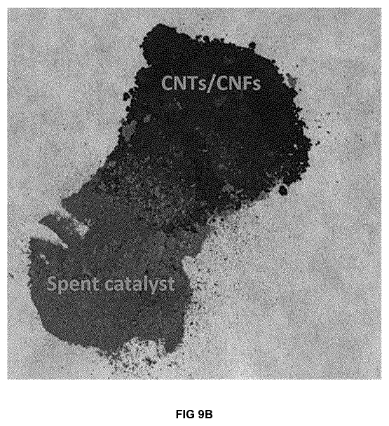

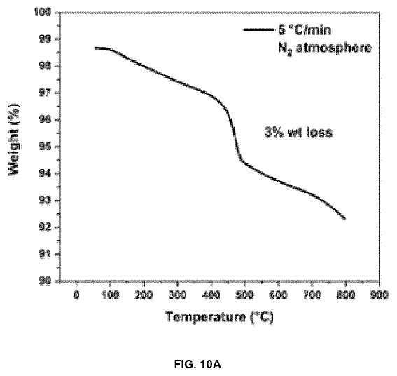

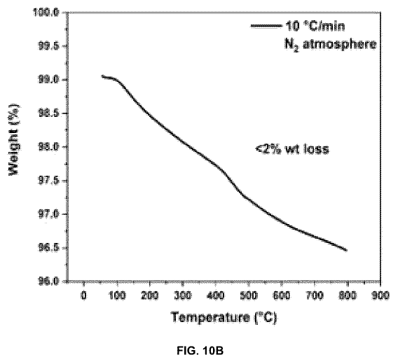

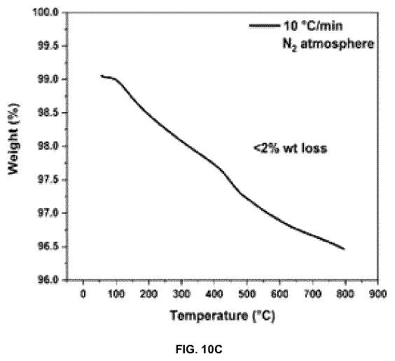

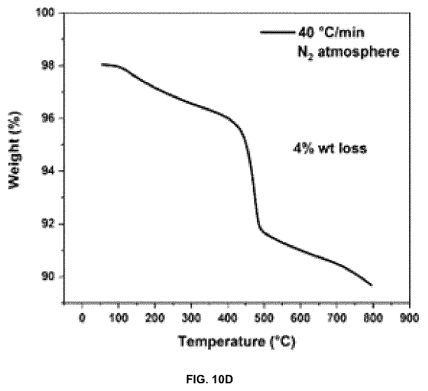

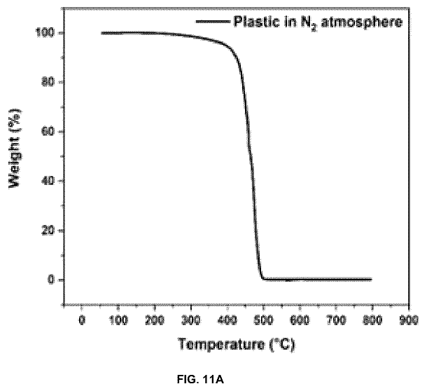

Polyethylene was pyrolyzed using nickel, iron, and cobalt catalysts according to the reaction conditions listed in Table 1 to identify the effect of metals on hydrogen yield and carbon quality. The products comprised gas and solid residue; no liquid was detected. FIG. 2A displays the gas composition of PE pyrolysis using different catalysts. It can be confirmed that 10% Fe/Al₂O₃ catalyst produces the highest amount of hydrogen, keeping other products at a minimum. Plastic was efficiently converted (>95%) into different products as per the thermogravimetric analysis (TGA) of spent catalysts performed in the nitrogen atmosphere (See FIG. 8A, FIG. 8B, FIG. 8C). Further details on TGA are discussed in the later section. Thus, for hydrogen selectivity, the iron-based catalyst is preferred. For the hydrogen yield part, 31.56, 43.02, and 41.99 mmol H₂/g_{plastic} were produced by 10% Ni/Al₂O₃, 10% Fe/Al₂O₃, and 10% Co/Al₂O₃ catalyst, respectively. After the reaction, a separate carbon layer was found on the top of the catalyst bed, shown in FIG. 9A and FIG. 9B.

### 6. Effect of Different Ramp Rates

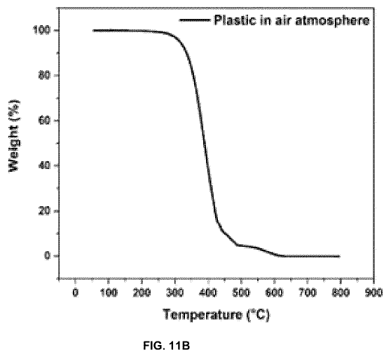

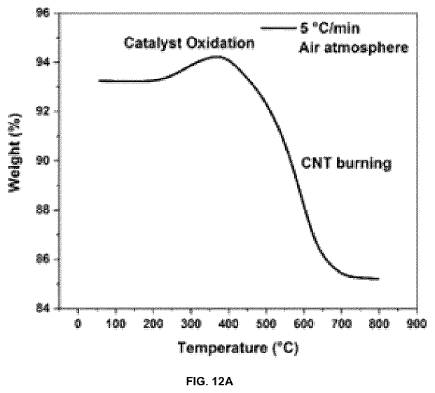

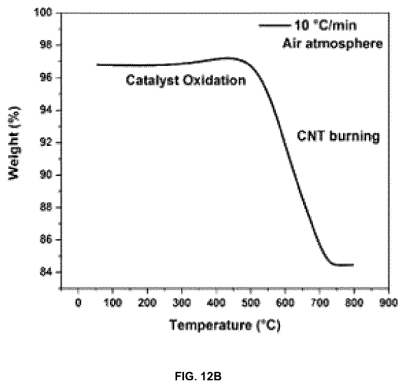

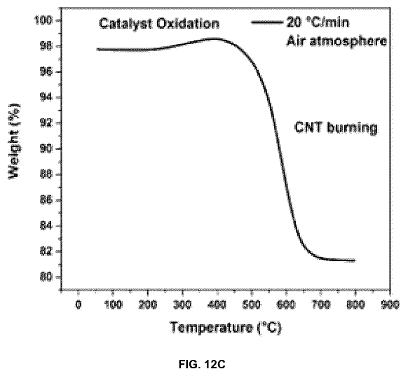

To identify the effect of temperature ramp rate on product gas composition and carbon quality, polyethylene (PE) was pyrolyzed using a 10% Fe/Al₂O₃ catalyst at different ramp rates. Their results are displayed in FIG. 2D. The ramp rate is apparently not related to gas selectivity. The TGA analysis of the spent catalyst in the nitrogen atmosphere (FIG. 10A, FIG. 10B, FIG. 10C, FIG. 10D) recorded a weight loss of <5% at 500° C. (i.e., the decomposition temperature of PE), confirming the percent of plastic conversion was >95%. The residue plastic decomposition temperature was confirmed by TG analysis of pure PE in a nitrogen atmosphere (FIG. 11A, FIG. 11B).

### 7. Calcined Catalyst Characterization

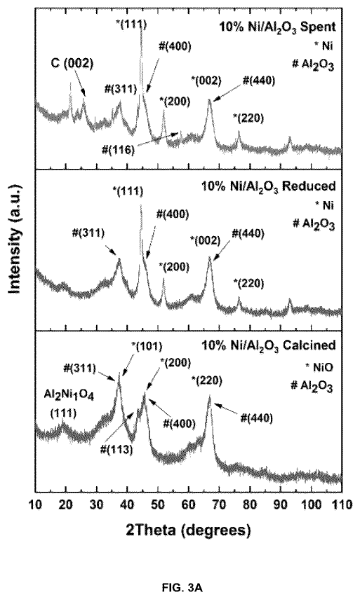

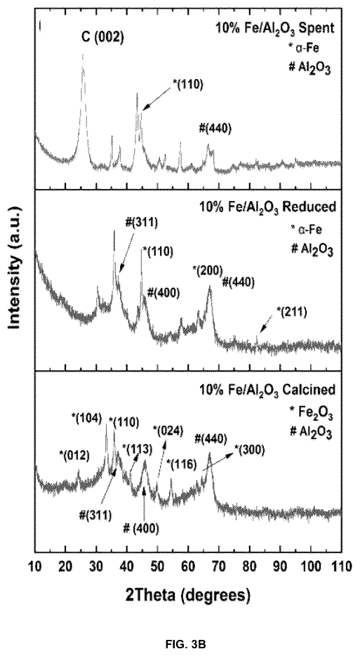

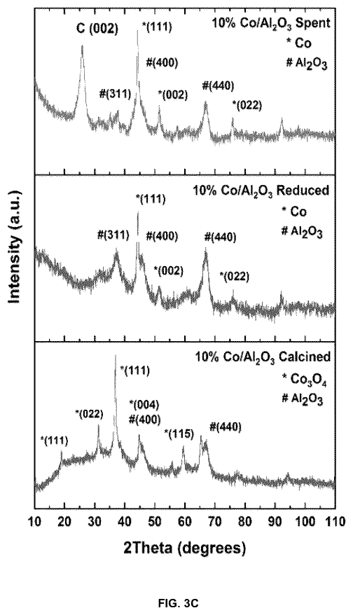

X-Ray Diffraction (XRD): FIG. 3A, FIG. 3B, and FIG. 3C show the XRD patterns of 10% Ni/Al₂O₃, 10% Fe/Al₂O₃, and 10% Co/Al₂O₃ for the calcined, reduced, and spent catalysts, respectively. All the catalysts display the peaks at 20=37.1, 45.6, and 66.6° corresponding to Al₂O₃ (311), (400), and (440) planes [17]. For the nickel-based catalysts, the calcined catalyst consists of NiO (101), (200), and (220) phases, which were further reduced to metallic nickel, i.e., Ni (111), (200), (002), and (220). For the 10% Fe/Al₂O₃ calcined catalyst, Fe₂O₃ is present along with alumina species. From the spectra of the reduced catalyst FIG. 3B it was confirmed that Fe₂O₃ was converted to a-Fe. From FIG. 3C, CO₃O₄ species can be observed for the cobalt-based calcined catalyst, which was then converted to metallic cobalt [18]. For all the Fe, Co, and Ni spent catalysts, the peak at 20=25.5° confirms the presence of the crystalline carbon (probable CNTs/CNFs) on the catalysts. Further, their d-spacing was also in-line with the d-spacing obtained in the transmission electron microscopy analysis.

### 8. Temperature Programmed Reduction (TPR)

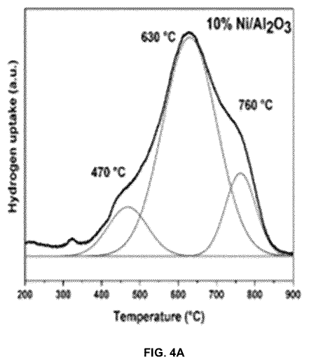

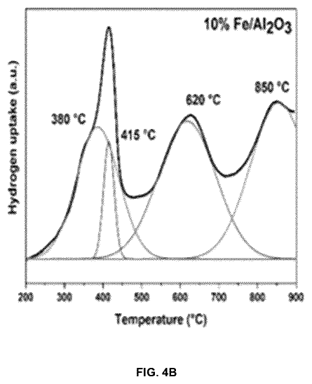

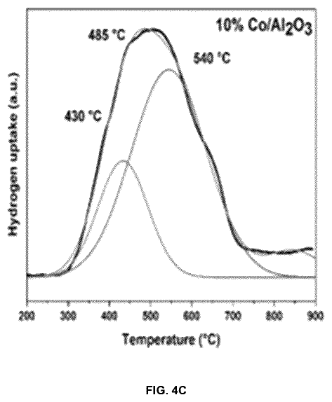

TPR was performed to identify the metal spices in the catalysts and their interactions with the support based on the reduction temperature (FIG. 4A, FIG. 4B, FIG. 4C). For the 10% Ni/Al₂O₃ reduction curve, a small hydrogen consumption peak at 470° C. was attributed to weak metal support (NiO—Al₂O₃) interaction. In comparison, a peak at 630° C. was attributed to strong metal-support (NiO—Al₂O₃) interaction. The small peak at 760° C. was due to the reduction of nickel dialuminium oxide. For the 10% Fe/Al₂O₃ reduction curve, the first major hydrogen consumption peaks around 380 and 415° C. were attributed to the conversion of Fe₂O₃ to Fe₃O₄ species. The second peak, around 620° C., was attributed to the reduction of Fe₃O₄ to Fe metal. Two major peaks can be identified for the 10% Co/Al₂O₃ reduction curve. The first major peaks at 430 and 485° C. were attributed to the conversion of Co₃O₄ to CoO, while the second peak was attributed to the conversion of CoO to Co metal.

### 9. Co Chemisorption and Production of CNTS/CNFS

CO chemisorption was utilized to obtain the metal dispersion (%), metallic surface area, and crystallite size of the metal crystals on various catalysts. Table 2 shows the results of the nickel, cobalt, and iron catalysts. It was observed that 10% Fe/Al₂O₃ catalyst displayed the highest metal dispersion with minimum crystallite size. It was also observed that crystallite size is directly related to the outside diameter of the produced CNTs/CNFs due to the carbon nanotube growth mechanism.

TABLE 2
Textural properties of calcined catalysts and carbon nanotubes

| | | Metal | Metallic | | CNT |
|---|---|---|---|---|---|
| Sr. | | Dispersion | surface area | Crystallite | diameter |
| No | Catalyst | (%) | (m²/g metal) | size (nm) | (nm) TEM |
| 1 | 10% Ni/Al₂O₃ | 2.4 | 16.2 | 34.7 | 25-30 |
| 2 | 10% Fe/Al₂O₃ | 6.5 | 34.8 | 18.2 | 20-22 |
| 3 | 10% Co—/Al₂O₃ | 4.4 | 29.5 | 19.1 | 15-25 |

### 10. Spent Catalyst-CNT Characterization

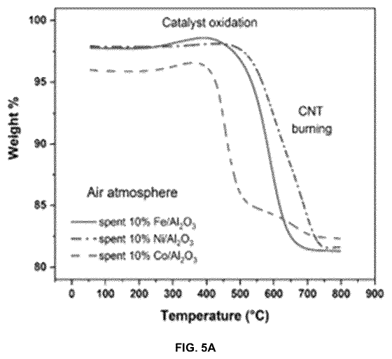

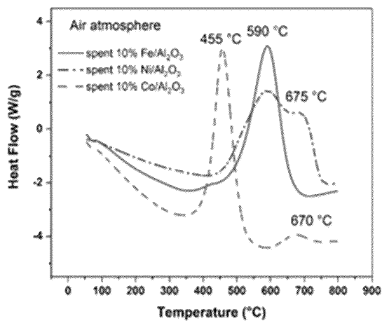

FIG. 5A and FIG. 5B show the Thermographic Analysis (TGA) and Differential Scanning (DSC) of the spent catalysts 10% Ni/Al₂O₃, 10% Fe/Al₂O₃, and 10% Co/Al₂O₃) in air. There is significant weight loss in the temperature range of 450-670° C., indicating the presence of a different type of crystalline carbon in the sample. No weight loss around 350° C. confirms the absence of amorphous carbon. For the cobalt and nickel-based catalysts, two different weight losses were observed, indicating the presence of two different types of carbon. For the spent cobalt catalyst, lower temperature weight loss (at 455° C.) suggests the presence of crystalline carbon with lower stability. Moreover, a weight loss at 670° C. indicates highly stable carbon; however, the amount is significantly low. For the spent nickel-based catalyst, weight loss at 590° C. and 675° C. indicates the presence of two different types of highly stable carbon. For the spent iron-based catalyst, a weight loss at 590° C. confirms the presence of highly crystalline carbon with uniform quality.

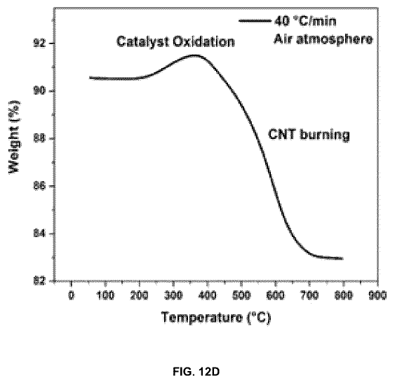

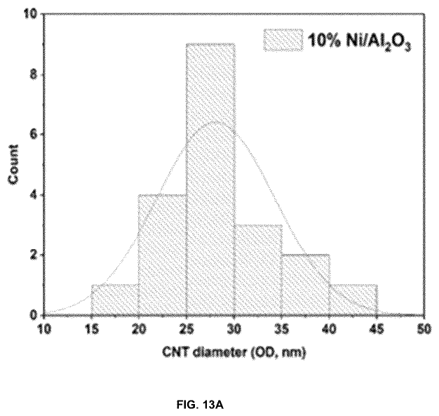

All the spent catalysts (10% Fe/Al₂O₃, different ramp rates) were analyzed by TGA analysis in nitrogen (FIG. 10A, FIG. 10B, FIG. 10C, FIG. 10D) and air atmosphere (FIG. 12A, FIG. 12B, FIG. 12C, FIG. 12D). Initially, the residue waste plastic would evaporate due to high temperature and inert nitrogen atmosphere, indicating the amount of unreacted PE in the spent catalysts. Later, the same spent catalyst was heated in the presence of air to identify the nature of the carbon present. FIG. 10A, FIG. 10B, FIG. 10C, and FIG. 10D show that plastic residue in the sample is <5% at 500° C. in the nitrogen atmosphere, indicating >95% PE conversion during the reaction. FIG. 12A, FIG. 12B, FIG. 12C, and FIG. 12D show the same spent catalyst samples heated in the air atmosphere. It was observed that major weight loss was between 550-650° C. indicating the presence of CNTs/CNFs.

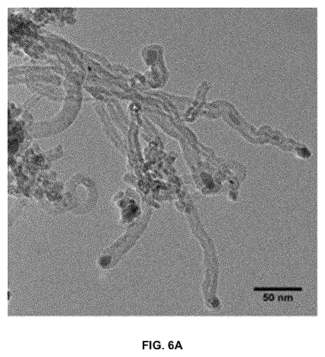

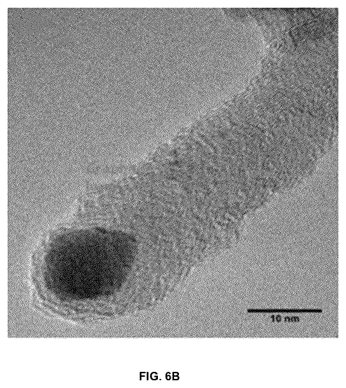

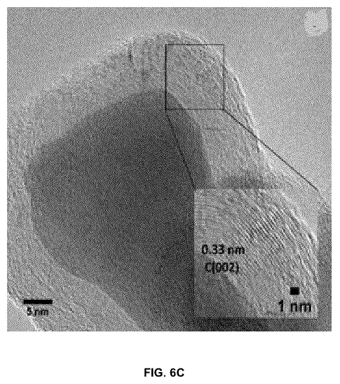

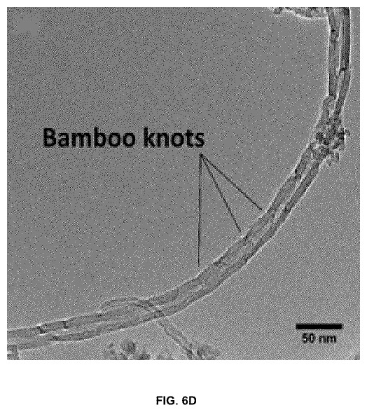

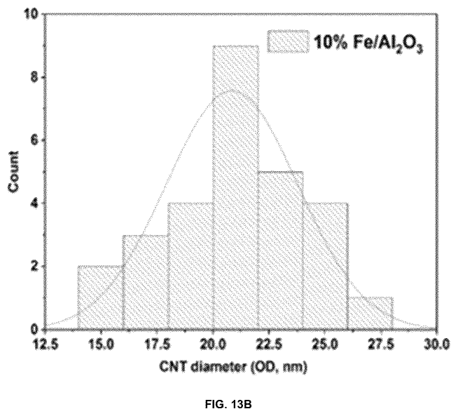

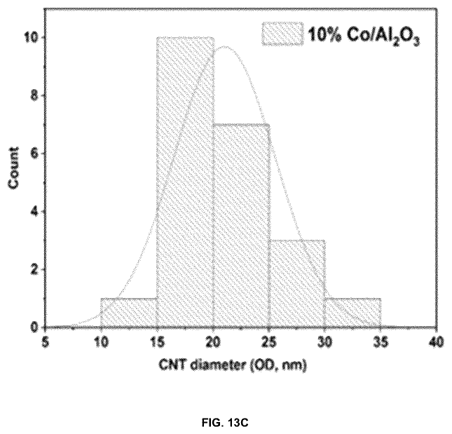

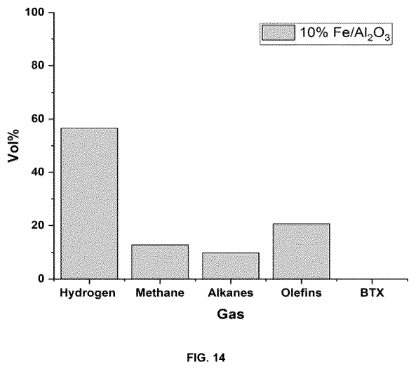

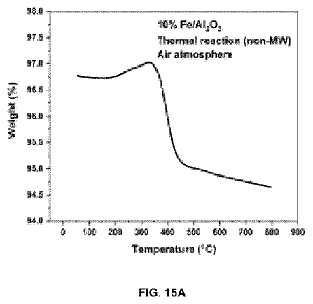

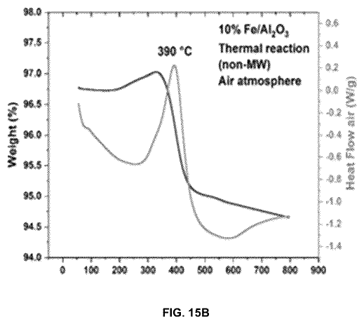

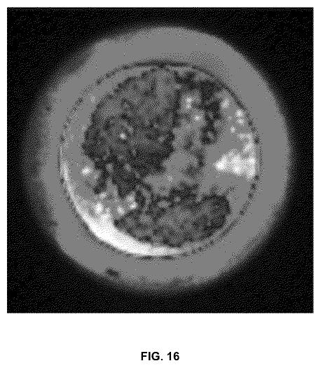

FIG. 6A, FIG. 6B, FIG. 6C, and FIG. 6D show the carbon produced from the 10% Ni/Al₂O₃ catalyst. The carbon produced appears to be valuable bamboo-shaped carbon nanofibers (CNFs). It was also observed from FIG. 6B that the graphite layers on the CNFs are tilted at certain degrees to the tube growth axis (i.e., (α/2) is <30°), which was also reported in the early literature [19]. Monthioux et al. showed that if the herringbone angle (a) is less than 60°, the CNTs should be bamboo-shaped with a hollow core. Similar results can be observed from the analysis of FIG. 6D. The CNF outside diameter distribution histogram (FIG. 13A, FIG. 13B, FIG. 13C) displays the diameter range of 25-30 nm, which is also in agreement with the particle size measured by CO chemisorption. The interlayer distance (0.33 nm) observed by high-resolution TEM image (FIG. 6C) indicates C (002) plane, also confirmed by XRD analysis (FIG. 3A). Overall, good-quality CNFs are generated by using a nickel catalyst. However, the outside diameter distribution is not particularly narrow, and produced nanofibers were entangled with each other with a high amount of metal impurity.

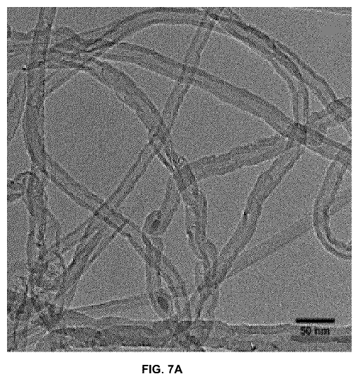

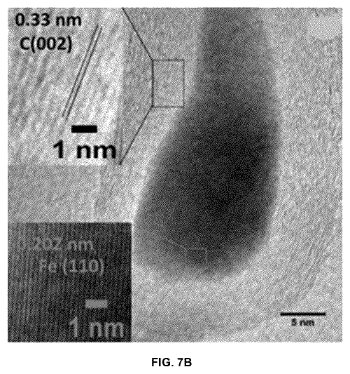

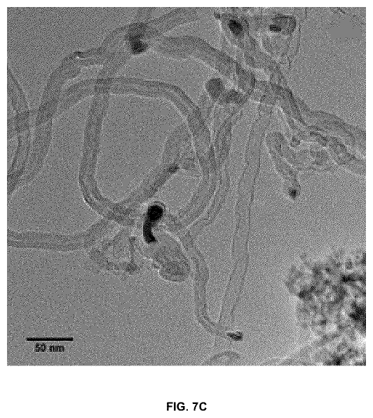

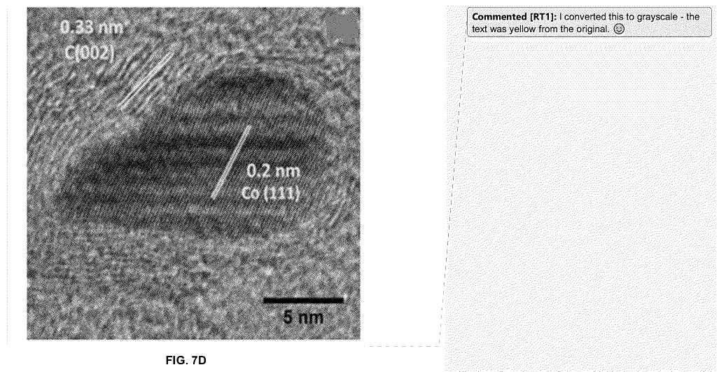

FIG. 7A and FIG. 7B shows carbon produced by 10% Fe/Al₂O₃ catalyst. It was observed that the carbon is in the form of carbon nanotubes (CNTs). Grown CNTs are highly uniform, with a minimum amount of impurity inside them. Further, the graphitic layers align with the growth axis with narrow size distribution. In the past, due to a slower carbon diffusion rate, bamboo-shaped carbon nanofiber was also observed [21]. However, in the present scenario, carbon nanotubes without bamboo-knot can be observed. From FIG. 7B, it can be observed that the d-spacing of the graphitic layer is 0.33 nm, indicating the C(002) plane, and the d-spacing of the metal particle is 0.202 nm indicating α-Fe (110) phase. Both these values are aligned with the X-ray diffraction results.

The CNT outside diameter distribution (FIG. 13A, FIG. 13B, FIG. 13C), which is dependent on the crystallite size, also agrees with the particle size obtained by the CO chemisorption. It was also observed that the iron particle is on the tip of the carbon nanotube, confirming the tip-growth mechanism. Thus, produced CNTs are of exceptionally high value due to their uniformity, low diameter distribution, and less impurity.

FIG. 7C and FIG. 7D show carbon produced by the 10% Co/Al₂O₃ catalyst. The carbon is in the form of CNTs and CNFs. Different types of straight and spiral kind of tubes can be seen. Further, according to the outside size distribution, most tubes are in the 15-25 nm range. These diameter data are in agreement with the CO chemisorption crystallite size data. It was concluded that cobalt catalyst could produce thin but non-uniform tubes.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A method for converting a plastic composition to value-added products, the method comprising:
providing a plastic composition to a reactor;
(a) contacting the plastic composition with a catalyst to form a reaction mixture;
(b) applying microwave radiation to the reaction mixture to heat the reaction mixture to a reaction temperature;
thereby forming the value-added products;
wherein the value-added products comprise a gaseous product and a solid product;
wherein the gaseous product comprises hydrogen; and
wherein the solid product comprises a carbon nanomaterial;
wherein the catalyst comprises a catalyst support and a catalyst metal;
wherein the catalyst support comprises an acidic support material; and
wherein the catalyst metal is selected from Fe, Co, Ni, and combinations thereof;
wherein the reaction temperature is from about 180° C. to about 600° C.

2. The method of claim 1, wherein the plastic composition is a waste plastic composition.

3. The method of claim 1, wherein the plastic composition is selected from the group consisting of an acrylic, polyamide, a polycarbonate, a polyester, a polyolefin, a polystyrene, and combinations thereof.

4. The method of claim 1, wherein the acrylic is selected from the group consisting of an acrylate polymer, an acrylic resin, an acrylic fiber, and acrylic paint, a methacrylate polymer, a methacrylate resin, an alkyl methacrylate polymer, and an alkyl methacrylate resin; and wherein the polyamide is selected from the group consisting of an aliphatic polyamide, a polyphthalamide, and an aromatic polyamide; wherein the polyolefin is selected from the group consisting of a polyurethane, a polyethylene, a polypropylene, a polybutylene, and combinations thereof.

5. The method of claim 1, wherein the acidic support material comprises a material selected from aluminum oxide, aluminum silicate, zeolite, and combinations thereof.

6. The method of claim 5, wherein the aluminum oxide has a silica content in SiO₂ equivalent less than or equal to about 10 wt % relative to the total weight of the acidic support material.

7. The method of claim 5, wherein the aluminum oxide is γ-Al₂O₃.

8. The method of claim 5, wherein the aluminum silicate is selected from the group consisting of an andalusite, a kyanite, a sillimanite, a metakaolinite, a mullite and a kaolinite.

9. The method of claim 5, wherein the aluminum silicate has a formula xAl₂O₃·ySiO₂; wherein x is an integer from 1 to 10; and wherein y is an integer from 1 to 10.

10. The method of claim 5, wherein the zeolite is Y zeolite; and wherein the zeolite has a Brønsted-acid site density of from about 50 μmol/g to about 1200 μmol/g of the zeolite wherein the Brønsted-acid site density as measured by the Brønsted-Acid Site Density Measurement Protocol.

11. The method of claim 1, wherein the acidic support material has a total pore volume from about 0.1 cm³/g to about 0.5 cm³/g; wherein the acidic support material has a specific surface area from about 100 m²/g to about 300 m²/g; and wherein the acidic support material comprises pores with a mean pore diameter from about 2 nm to about 20 nm.

12. The method of claim 1, wherein the gaseous product comprises from about 85% to 100% hydrogen gas by volume at atmospheric pressure and ambient temperature; and wherein the gaseous product contains less than 1% of a COx gas by volume at atmospheric pressure and ambient temperature.

13. The method of claim 17, wherein the gaseous product is substantially free of a COx gas.

14. The method of claim 1, wherein the catalyst and plastic composition are present in a w/w ratio from about 20:1 to about 1:20.

15. The method of claim 1, wherein the microwave irradiation heats the reaction mixture to a bulk temperature from about 200° C. to 500° C.

16. The method of claim 1, wherein the hydrogen is produced in a yield of from 20 to 60 mmol H₂ per gram of plastic composition; and wherein the carbon nanomaterial is produced in a yield from about 80% to about 99% carbon based on the weight of carbon in the plastic composition.

17. The method of claim 1, wherein the catalyst metal is present in an amount from about 0.1 wt % to about 40 wt % metal based on the total weight of the support and the metal.

18. The method of claim 1, wherein the catalyst metal is selected from Ni, Co, and Fe.

19. The method of claim 1, wherein the catalyst further comprises a catalyst promoter metal selected from Pt, Pd, and a combination thereof.

20. The method of claim 1, wherein the catalyst metal is produced by hydrogenation of a catalyst oxide selected from the group consisting of a nickel oxide, an iron oxide, and a cobalt oxide.

21. A carbon nanomaterial made using the method of claim 120.
